(19) United States
(12) Patent Application Publication
(10) Pub. No.: US 2006/0091062 A1
(43) Pub. Date: May 4, 2006

(54) Filtering device

(75) Inventors: Hideo Akahori, Fujisawa-shi (JP); Toshihiro Aramaki, Fujisawa-shi (JP); Hiroyasu Shirakawa, Fujisawa-shi (JP)

Correspondence Address: JACOBSON HOLMAN PLLC, 400 SEVENTH STREET N.W., SUITE 600, WASHINGTON, DC, 20004, US

(73) Assignee: NOK CORPORA6TION

(21) Appl. No.: 10/537,997

(22) PCT Filed: Oct. 15, 2003
(86) PCT No.: PCT/JP03/13193

§ 371 Date: Jun. 9, 2005

(51) Int. Cl. B01D 35/28

(52) U.S. Cl. 210/448; 210/450; 210/452; 210/303; 210/299

(57) ABSTRACT

The present invention relates to a filter device for removing impurities in a liquid. A filter bag 2 and a bag filter bucket 3 are disposed so that their opening portions are oriented downward. An annular gap between an outer peripheral face of the bag filter bucket 3 and an inner peripheral face of a main body 41 of a filter housing 4 is sealed with a seal ring 8. The bag filter bucket 3 has a configuration in which a handle 10 is positioned inside a tip end portion of a cylindrical portion. The tip end portion of the cylindrical portion of the bag filter bucket 3 is brought into contact with a position restricting portion 51.

### TECHNICAL FIELD

The present invention relates to a filter device for removing impurities contained in liquid, and so on.

### BACKGROUND ART

There has been conventionally used a filter device by the use of a bag filter for the purpose of cleaning of cleaning liquid which had been used for washing parts and cutting or the disposal of waste liquid which had been used for washing food and in a field of medical care.

In the cleaning of the cleaning liquid and the disposal of the waste liquid, it is necessary to remove impurities in the liquid by filtration. It is necessary in some cases to remove impurities of higher specific gravity such as pieces of metal contained in liquid or components of lower specific gravity such as an oil component contained in liquid by specific gravity difference separation.

In such cases, the impurities are normally separated by filtering by the use of a filter device having a bag filter. The components of lower specific gravity are separated by specific gravity difference separation by an additional tank such as a coalescer independently of the bag filter.

On the other hand, the applicant of the present application has already filed an application with regard to an invention of a filter device for performing all of separation by filtration, removal of impurities of higher specific gravity by specific gravity difference separation, and removal of components of lower specific gravity by specific gravity difference separation (Japanese Patent Application No. 2001-250749).

This filter device will be described by reference to FIGS. 8 to 10. FIG. 8 is a schematic sectional view of the filter device for both the filtration separation and the specific gravity difference separation. FIG. 9 is a perspective view of a concrete example of an opening end seal. FIG. 10 is a part of a perspective view of a protecting member (bag filter bucket).

The filter device 100 includes a filter bag (i.e., bag-like filter) 101 disposed so that its opening portion is oriented downward, a bag filter bucket 102 for protecting the filter bag 101, and a filter housing 103 for accommodating them.

The bag filter bucket 102 is a member formed of a rigid body substantially in a cylindrical shape with a bottom. Holes are provided substantially throughout a side face and a bottom face of the bag filter bucket 102 (only a part of the holes are shown in FIG. 7). Therefore, it is possible to protect the filter bag 101 without obstructing a flow of filtered liquid.

A handle 107 is attached to an outside face of the bottom of the bag filter bucket 102. With this handle 107, it is possible to easily attach and detach the filter bag 101 and the bag filter bucket 102 to and from the filter housing 103.

To an upper portion of the filter housing 103, a housing cover 104 is attached. These filter housing 103 and housing cover 104 form a housing. In a lower portion of the housing, a deposit recovery tank R1 for removing impurities of higher specific gravity is formed. In an upper portion of the housing, a floating material recovery tank R2 for removing components of lower specific gravity is formed.

An opening portion 103a is formed in a lower end of the deposit recovery tank R1. The deposited impurities of higher specific gravity can be removed through this opening portion 103a. An opening portion 104a is formed in an upper end of the floating material recovery tank R2. The floating components of lower specific gravity can be removed through this opening portion 104a.

In the housing, a ring 105 is mounted. Between the ring 105 and the filter bag 101 and bag filter bucket 102, the opening end seal 106 is disposed.

Positioning of these members is as follows. The housing cover 104 is attached to the filter housing 103. As a result, the handle 107 provided to the bag filter bucket 102 is pressed by a presser 104b provided to the housing cover 104. Thus, the opening end seal 106 is pressed against the ring 105 through the bag filter bucket 102.

In the above manner, the filter bag 101 and the bag filter bucket 102 are positioned and fixed. A sealing function of the opening end seal 106 is exhibited.

The case in which filtration is performed by using the filter device 100 formed as described above will be described. First, liquid to be filtered flows in from an inlet 103c provided to the filter housing 103. The liquid filtered by the filter bag 101 flows out from an outlet 103b provided to the filter housing 103.

Out of impurities separated by the filter bag 101, impurities of higher specific gravity than the liquid to be filtered are gradually deposited. Then, these impurities are recovered in the deposit recovery tank R1.

On the other hand, components such as an oil component of lower specific gravity contained in the liquid to be filtered float up to the upper portion. Then, these light components pass through the filter bag 101 and are recovered in the floating material recovery tank R2.

As described above, with a single device, it is possible to perform both the filtration separation by using the filter and the specific gravity difference separation of the impurities of higher specific gravity and the components of lower specific gravity. In the filter device 100, the filter bag 101 is disposed so that its opening portion is oriented downward. Therefore, the device has an advantage that impurities do not stay in the filter bag 101 to thereby suppress clogging of the filter.

The opening end seal 106 is provided to the filter device 100. Therefore, it is possible to prevent the liquid to be filtered from flowing out from the outlet 103b before filtration of the liquid by the filter bag 101.

In order to allow the opening end seal 106 to sufficiently exhibit its sealing function, it is necessary to press the opening end seal 106 against the ring 105 with a sufficient force. Therefore, it is necessary to press the handle 107 provided to the bag filter bucket 102 by the presser 104b with a relatively large force.

As a result, pressure is concentrated on the presser 104b and the handle 107 and the presser 104b and the handle 107 may be deformed. During use of the filter device 100, the pressure concentration further increases due to fluid pressure of the liquid to be filtered. Moreover, prevention of such deformation causes inconvenience of increasing rigidity of the presser 104b and the handle 107.

As a concrete configuration of the opening end seal 106, there are configurations shown in FIGS. 9(A) and 9(B), for example.

That is to say, the opening end seal 106 has ring-like portions for respectively receiving pressure on opposite ends of the seal 106 and a bellows portion which can elastically be deformed between the ring-like portions. In order to allow the seal 106 to exhibit a certain elastic force, a spring 106a is provided as in the opening end seal 106A shown in FIG. 9(A) or a plate spring 106b is provided as in the opening end seal 106B shown in FIG. 9(B).

The complicated configuration of such an opening end seal causes inconvenience of an increasing in the number of parts. As a result, an assembly operation becomes complicated. Consequently, a cost of manufacturing increases.

### DISCLOSURE OF THE INVENTION

Objects of the invention of the present application are to achieve both of removal of impurities by filtration and removal of impurities by specific gravity separation and to simplify a configuration.

To achieve these objects, a filter device of the invention of the present application comprises a bag-like filter for filtering particles of impurities. The filter is accommodated in a housing so that an opening portion of the filter is oriented downward. The housing has an inlet below the opening portion of the filter and an outlet above the opening portion of the filter.

With this structure, a liquid to be filtered, which has flowed into the housing from the inlet, enters the filter from the opening portion of the filter. Only the liquid filtered by the filter is allowed to flow out of the housing from the outlet.

On the other hand, the particles of the impurities separated by the filter is gradually deposited due to gravity against a flow of the fluid to be filtered or in a state in which the fluid to be filtered is not flowing. Then, the particles are discharged outside the filter through the opening of the filter. Therefore, separation by filtration and specific gravity difference separation can be carried out by a single device.

In the invention of the present application, a deposit recovery tank for recovering the deposited particles below an opening end of the filter is provided.

By providing the deposit recovery tank in this manner, it is possible to prevent the particles of the impurities from staying inside the filter. Therefore, it is possible to stabilize filtration performance and to prolong a lifetime of the filter.

It is preferable to provide a floating material recovery tank into which components of lower specific gravity are floated up and recovered. Thus, both the particles of higher specific gravity and components of lower specific gravity can be separated by the specific gravity separation.

In the invention of the present application, a protecting member for protecting the filter is provided. It is preferable to provide a seal for sealing an annular gap between an outer peripheral face of the protecting member and an inner peripheral face of the housing.

This seal prevents the liquid, to be filtered, which has flowed in from the inlet provided to the housing from flowing out from the outlet before filtration of the liquid by the filter.

With this seal, the annular gap between the outer peripheral face of the protecting member and the inner peripheral face of the housing is sealed as described above. Therefore, a complicated configuration such as an end face seal is unnecessary. Moreover, a configuration for strongly pressing the filter and the protecting member in a vertical direction is unnecessary.

As a concrete example of this seal, there is a seal ring such as an O ring.

It is also preferable to provide a sleeve fitted with the inner periphery of the housing. In this case, the above-described seal forms seal faces respectively on the outer peripheral face of the protecting member and an inner peripheral face of the sleeve to thereby exhibit a sealing function.

Provision of this sleeve has the following advantages. In order to obtain a satisfactory sealing property, high dimensional accuracy and high working accuracy of a surface are required of a portion with which the seal comes in close contact. On the other hand, working for enhancing dimensional accuracy and the like of the inner peripheral face of the housing is difficult in some cases. Therefore, by providing the sleeve and enhancing dimensional accuracy and the like of the sleeve, the seal can exhibit stable sealing performance. In some cases, the seal is mounted into the housing with the outer peripheral face of the seal in sliding contact with the inner periphery of the housing. In this case, if the outer peripheral face is in sliding contact by a long distance, the seal may wear or may not be mounted in a satisfactory condition. On the other hand, if the sleeve is provided, such a problem can be solved.

An end portion of the sleeve is preferably provided with a taper for leading the protecting member to a predetermined mounting position when the protecting member is mounted into the housing. Thus, a mounting operation of the protecting member is facilitated.

It is preferable to provide a seal portion for sealing a path of the liquid to be filtered entering a gap between an inner peripheral face of the protecting member and an outer peripheral face of the filter.

As a result, it is possible to prevent a leak from between the inner peripheral face of the protecting member and the outer peripheral face of the filter as well as a leak from the inner peripheral face of the housing by the above-described seal. Therefore, the liquid to be filtered can more effectively be prevented from flowing out from the outlet without being filtered by the filter.

Vertical positioning of the filter and the protecting member is preferably carried out by using the support member mounted in the housing main body and the position restricting portion provided to the housing cover.

The filter device of the invention of the present application is preferably formed so that the position restricting portion provided to the housing cover and the protecting member are not deformed even if pressure acts on portions of the position restricting portion and the protecting member in contact with each other.

As a configuration for preventing deformation, one or both of configurations for dispersing the pressure and enhancing rigidity of the members is (are) employed.

One of concrete configurations is a configuration in which a tip end portion of a cylindrical portion of the protecting member is abutted on the position restricting portion.

Thus, it is possible to disperse the pressure.

In this case, if the position restricting portion has an area on which the whole tip end portion of the cylindrical portion of the protecting member is abutted, it is possible to sufficiently disperse the pressure.

As another configuration, there is a configuration in which a cross-shaped handle having longwise and crosswise lengths each substantially equal to a diameter of the protecting member is provided to an outside face of a bottom of the protecting member and is abutted on the position restricting portion.

Thus, it is possible to enhance rigidity of an end portion of the protecting member and to disperse the pressure.

In this case, if the position restricting portion has an area on which the whole surface of the handle on the position restricting portion side is abutted, it is possible to sufficiently disperse the pressure.

### BRIEF DESCRIPTION OF THE DRAWINGS

FIG. 1 is a schematic sectional view of a filter device according to a first embodiment of the invention of the present application;

FIG. 2 is an enlarged view of a seal portion in FIG. 1;

FIG. 3 is a figure showing a manner of mounting of a filter in the filter device according to the first embodiment of the invention of the present application;

FIG. 4 is a part of a perspective view of a protecting member in the filter device according to the first embodiment of the invention of the present application;

FIG. 5 is a bottom view of a housing cover in the filter device according to the first embodiment of the invention of the present application;

FIG. 6 is a bottom view of a housing cover in a filter device according to a second embodiment of the invention of the present application;

FIG. 7 is apart of a perspective view of a protecting member in a filter device according to a third embodiment of the invention of the present application;

FIG. 8 is a schematic sectional view of a filter device according to the conventional art and for performing both of filtration separation and specific gravity difference separation;

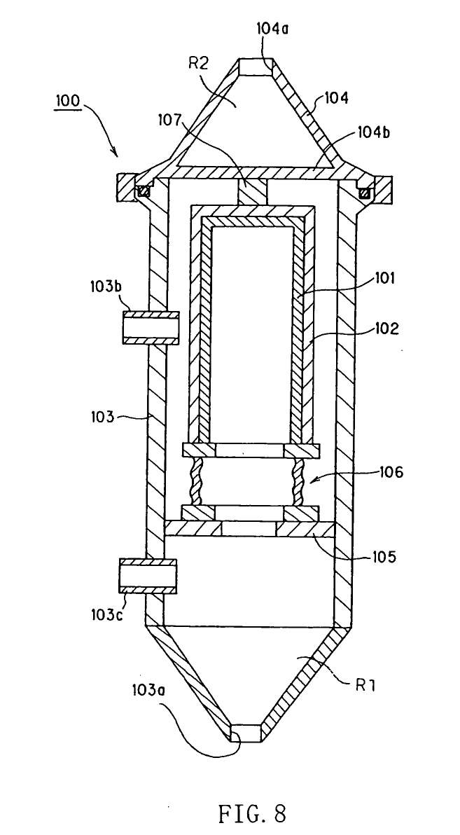

FIGS. 9(A) and 9(B) are perspective views showing concrete examples of an opening end seal; and

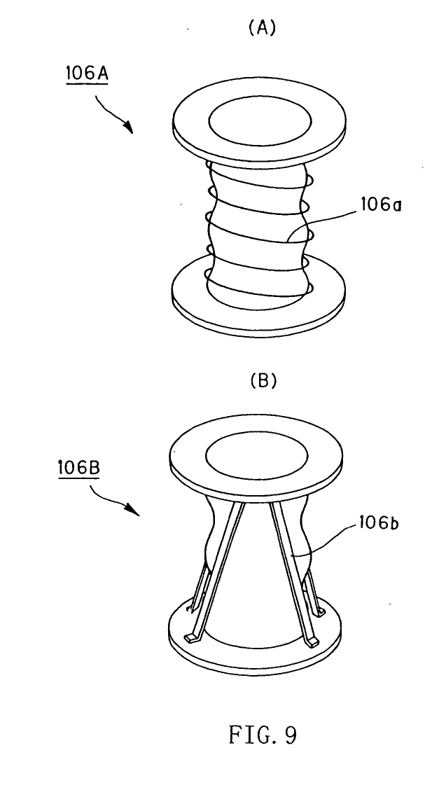

FIG. 10 is a part of a perspective view of a protecting member in the filter device shown in FIG. 8.

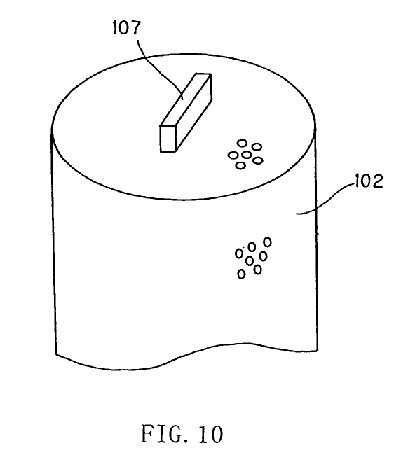

### BEST MODE FOR CARRYING OUT THE INVENTION

Preferred embodiments of the present invention will be illustratively described below in detail by reference to the accompanying drawings. Incidentally, the dimension, material, shape, relative arrangement and the like of constituent parts described in the embodiments are not limited to them with respect to the scope of the invention unless there are specified descriptions.

### FIRST EMBODIMENT

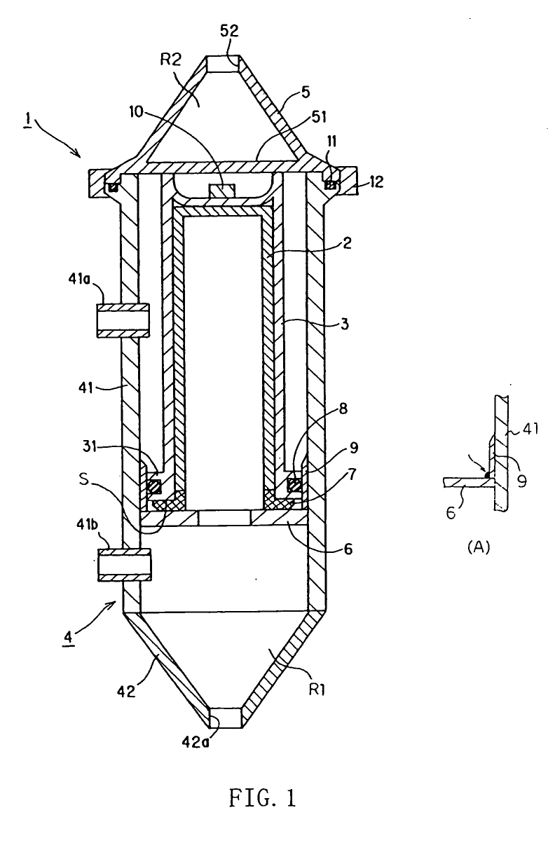

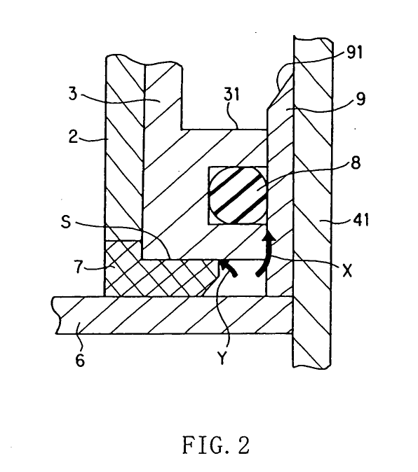

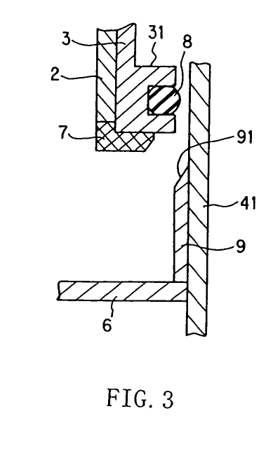

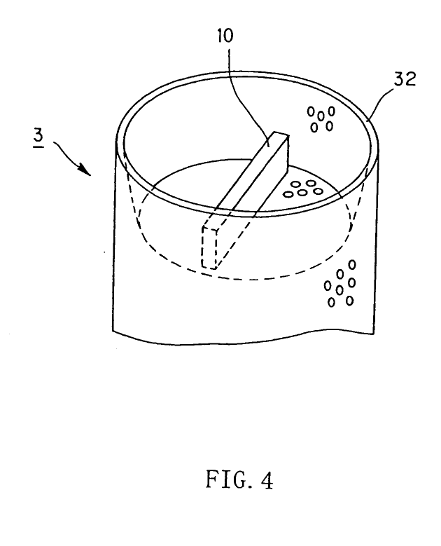

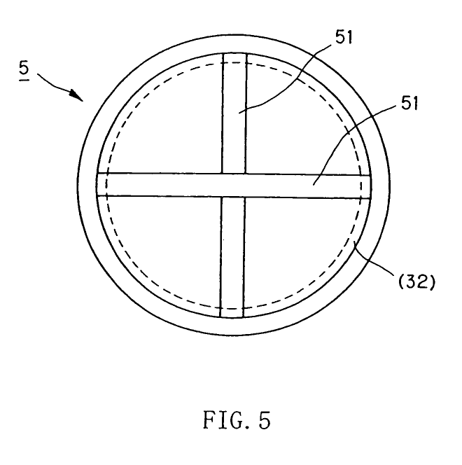

Referring to FIGS. 1 to 5, explanation will be made on a filter device according to a first embodiment of the invention of the present application. FIG. 1 is a schematic sectional view of the filter device according to the first embodiment of the invention. FIG. 2 is an enlarged view of a seal portion in FIG. 1. FIG. 3 is a figure showing a manner of mounting of a filter (filter bag) in the filter device according to the first embodiment of the invention of the present application. FIG. 4 is a part of a perspective view of a protecting member (bag filter bucket) in the filter device according to the first embodiment of the invention of the present application. FIG. 5 is a bottom view of a housing cover in the filter device according to the first embodiment of the invention of the present application.

The filter device 1 according to the embodiment includes a filter bag (bag-like filter) 2 disposed so that its opening portion is oriented downward, a bag filter bucket 3 as a protecting member for protecting the filter bag 2, and a filter housing 4 for accommodating them.

The bag filter bucket 3 is a member formed of a rigid body such as metal and substantially in a cylindrical shape with a bottom. Meshes are formed in a body portion (bottom and cylinder portions) of the bucket 3 or holes are provided substantially throughout the body portion. Therefore, the bag filter bucket 3 can protect the filter bag 2 without obstructing a flow of liquid filtered by the filter bag 2. A handle 10 is provided to the bottom portion of the bag filter bucket 3. By pushing in or pulling the handle 10, the filter bag 2 and the bag filter bucket 3 are attached into or detached from the filter housing 4.

The filter housing 4 has a substantially cylindrical main body 41 and a substantially conical portion 42 provided under the main body 41 and having a diameter reducing downward. The main body 41 has an inlet 41b for leading the liquid to be filtered into the filter device 1 below the opening portions of the filter bag 2 and the bag filter bucket 3. The main body 41 also has an outlet 41a for leading the liquid filtered by the filter bag 2 outside above the opening portions.

To an upper portion of the filter housing 4, a housing cover 5 is attached. To mating surfaces of the filter housing 4 and the housing cover 5, a seal ring (o ring) 11 is mounted. With this seal ring 11, a leak of the liquid can be prevented. To peripheries of the mating surfaces, a clamp 12 for mounting the filter device 1 at a predetermined position is provided.

These filter housing 4 and housing cover 5 form a housing. In a lower portion of the housing, a deposit recovery tank R1 for removing impurities of higher specific gravity is formed. In an upper portion of the housing, a floating material recovery tank R2 for removing components of lower specific gravity is formed.

The deposit recovery tank R1 is formed of a substantially conical portion 42 provided with a tapered face having a diameter reducing downward. An opening portion 42a is formed in a lower end of the substantially conical portion 42. The impurities of higher specific gravity can be removed through this opening portion 42a.

The housing cover 5 forming the floating material recovery tank R2 has a tapered face having a diameter reducing upward. An opening portion 52 is formed in an upper end of the housing cover 5. The components of lower specific gravity can be removed through this opening portion 52.

Next, by reference to FIGS. 2 and 3, a sealing mechanism portion will particularly be described in detail.

A seal ring mounting portion 31 is formed in the vicinity of an opening end of the bag filter bucket 3. At the seal ring mounting portion 31, an annular groove into which a seal ring (o ring) 8 is mounted is formed.

The seal ring 8 prevents entrance (an arrow X in the drawing) of the liquid to be filtered into an annular gap between an outer peripheral face of the bag filter bucket 3 and an inner peripheral face of the main body 41 of the filter housing 4.

A filter head 7 is mounted to the opening end of the bag filter bucket 3. The filter head 7 performs positioning of the opening end of the bag filter bucket 3 and an opening end of the filter bag 2. The filter head 7 also forms a seal portion S for preventing entrance (an arrow Y in the drawing) of the liquid to be filtered into a gap between an inner peripheral face of the bag filter bucket 3 and an outer peripheral face of the filter bag 2.

Thus, with the seal ring 8 and the seal portion S, the liquid to be filtered is prevented from being mixed with the filtered liquid without being filtered by the filter bag 2.

In the present embodiment, a sleeve 9 is fitted with an inner periphery of the main body 41 of the filter housing 4. An outer peripheral face of the sleeve 9 is fused and fixed to the inner peripheral face of the main body 41 of the filter housing 4. However, the sleeve 9 may be fixed by welding (fusion fixing) with a ring 6 as shown by an arrow in FIG. 1(A). The seal ring 8 forms seal faces respectively on the outer peripheral face of the bag filter bucket 3 and an inner peripheral face of the sleeve 9. Therefore, the annular gap between the outer peripheral face of the bag filter bucket 3 and the inner peripheral face of the main body 41 of the filter housing 4 is sealed.

The sleeve 9 is provided for the following reason.

In general, in order to obtain a satisfactory sealing property, high dimensional accuracy and high working accuracy of a surface are required of a portion with which the seal comes in close contact.

Therefore, when the seal face is directly formed on the inner peripheral face of the main body 41 of the filter housing 4, high dimensional accuracy and high working accuracy of a surface are required of the inner peripheral face of the main body 41. However, needless to say, it is more difficult to enhance dimensional accuracy of a relatively large member such as the filter housing 4 than to enhance dimensional accuracy of a smaller member. Moreover, it is difficult to enhance working accuracy of the inner peripheral surface of the main body 41.

Therefore, in the embodiment, a configuration including the sleeve 9 which is a smaller member than the filter housing 4 is employed. Consequently, dimensional accuracy of the inner periphery of the sleeve 9 which is a relatively small member and working accuracy of a surface of the inner periphery can easily be enhanced as compared with those of the filter housing 4. Therefore, there is an advantage that the sealing property can easily be enhanced.

The seal ring 8 is mounted as follows. First, the seal ring 8 is mounted into the annular groove in the seal ring mounting portion 31 provided to the bag filter bucket 3. Then, the bag filter bucket 3 is mounted into the filter housing 4. Thus, the seal ring 8 forms the seal face at a predetermined position.

Incidentally, the bag filter bucket 3 is inserted into the filter housing 4 from the opening end side (a side on which the housing cover 5 is attached) of the filter housing 4.

In this case, if there is not the sleeve 9, an outside diameter of the seal ring 8 has to be such a dimension that seal ring 8 comes in close contact with the inner peripheral face of the main body 41 of the filter housing 4.

However, as shown in FIG. 1, a cylindrical portion forming the outlet 41a extends to an inside of the main body 41 of the filter housing 4 in the embodiment. Therefore, insertion of the bag filter bucket 3 becomes difficult or impossible for this cylindrical portion.

Even if the cylindrical portion forming the outlet 41a does not extend to the inside of the main body 41 of the filter housing 4, the seal ring 8 slides a relatively long distance on the inner peripheral face of the main body 41 of the filter housing 4 during insertion of the bag filter bucket 3.

As a result, the seal ring 8 may wear or the seal ring 8 may not be mounted in a satisfactory condition.

On the other hand, if the sleeve 9 is provided, it is possible to reduce diameters of the seal ring 8 and the seal ring mounting portion 31 which is provided to the bag filter bucket 3 and to which the seal ring 8 is mounted. Thus, during insertion of the bag filter bucket 3, the seal ring 8 can be prevented from coming in contact with the inner peripheral face of the main body 41 of the filter housing 4 (see FIG. 3). Consequently, the bag filter bucket 3 can easily be inserted. Moreover, wearing of the seal ring 8 can also be prevented.

A taper 91 is formed at a tip end portion of the sleeve 9.

Thus, the bag filter bucket 3 is inserted with its tip end along the taper 91 of the sleeve 9. Consequently, the sleeve 9 can easily be mounted to a predetermined mounting position.

By providing the sleeve 9 as described above, it is possible to easily meet dimensional accuracy and working accuracy requirements. As a result, it is possible to exhibit the stable sealing property. Furthermore, the bag filter bucket 3 can easily be mounted.

Next, positioning configurations for the filter bag 2 and the bag filter bucket 3 will be described.

In the housing, the ring 6 is mounted as a support member for positioning the filter bag 2 and the bag filter bucket 3.

On the other hand, a position restricting portion 51 is formed at the housing cover 5. The position restricting portion 51 is a cross-shaped beam provided to a lower end of a substantially conical shape as shown in FIG. 5 in the embodiment. Thus, the position restricting portion 51 does not cover the whole lower end face of the housing cover 5. Therefore, the portion 51 does not obstruct a flow of fluid from the main body 41 side of the filter housing 4 to the housing cover 5 side.

When the housing cover 5 is mounted to the filter housing 4, the filter bag 2 and the bag filter bucket 3 are positioned between the position restricting portion 51 and the ring 6.

Here, in the embodiment, the annular gap between the outer peripheral face of the bag filter bucket 3 and the inner peripheral face of the main body 41 of the filter housing 4 is sealed with the seal ring 8 as described above. Therefore, it is unnecessary to strongly press the filter bag 2 and the bag filter bucket 3 with the position restricting portion 51 to push the filter bag 2 and the bag filter bucket 3 against the ring 6.

However, it is necessary to prevent the seal ring 8 from being displaced from a predetermined sealing position. Therefore, positioning of the filter bag 2 and the bag filter bucket 3 in a vertical direction is necessary. Consequently, vertical dimensions of the filter bag 2 and the bag filter bucket 3 need be substantially equal to a distance between the position restricting portion 51 and the ring 6.

If the fluid to be filtered flows into the filter bag 2 and the bag filter bucket 3, the filter bag 2 and the bag filter bucket 3 expand due to pressure of the fluid. Consequently, the position restricting portion 51 receives a pressing force from the bag filter bucket 3.

Here, in the embodiment, the bag filter bucket 3 has a configuration in which the handle 10 is positioned inside a tip end portion 32 of a cylindrical portion as shown in FIGS. 1 and 4. The tip end portion 32 of the cylindrical portion of the bag filter bucket 3 abuts on the position restricting portion 51.

In FIG. 5, a position corresponding to the tip end portion 32 of the cylindrical portion of the bag filter bucket 3 is shown in a dotted line. As can be seen from this drawing, the circular tip end portion 32 abuts on the cross-shaped position restricting portion 51 provided to the housing cover 5. In other words, the tip end portion 32 abuts on the position restricting portion 51 at four evenly spaced positions.

As a result, it is possible to ease pressure concentration occurring between the bag filter bucket 3 and the housing cover 5. That is to say, if only the handle in the vicinity of a center is abutted on the position restricting portion, pressure is concentrated on the vicinity of the center. On the other hand, if the pressure is received at the four evenly spaced positions at a distance from the center as in the embodiment, the pressure concentration can be eased greatly.

For the above reasons, even if the filter bag 2 and the bag filter bucket 3 expand due to the inside fluid pressure, the pressure received by the position restricting portion 51 and the like does not increase so much. Therefore, the deformation problem is solved.

In the embodiment, the handle 10 does not abut on the position restricting portion 51. However, it is also possible to employ a configuration in which the handle 10 as well as the tip end portion 32 of the cylindrical portion is abutted on the position restricting portion 51. In this case, it is possible to further ease the pressure concentration.

Explanation will be made below on the case where a water-based metallic part cleaning liquid (hereinafter simply referred to as “a cleaning liquid”) as one example of the liquid to be filtered is filtered by the filter device 1 configured as described above. Here, the cleaning liquid contains therein (1) chippings of a workpiece (i.e., settling fine particles), (2) floating oil (i.e., a floating oil component) and (3) suspended scum as impurities.

First, the cleaning liquid flows in through the inlet 41b, and then, advances into the filter bag 2. Through the membrane of the filter, (1) the settling fine particles and (3) the suspended scum out of the impurities are separated by the filtration.

The impurities, each of which has a diameter greater than the pore diameter of the filter and cannot be trapped at the surface of the filter or inside of the filter, in particular, (1) the settling particles have a specific gravity higher than that of the cleaning liquid, and therefore, they are gradually deposited. The settling particles are finally recovered in the deposit recover tank R1.

The floating oil component contained in the cleaning liquid has a specific gravity lower than that of the cleaning liquid and therefore floats up through the filter. The oil component is recovered in the floating material recovery tank R2. Here, it is preferable that the lipophilic material (for example, polypropylene) is employed as the material of the filter. In this manner, the filter can promote the coarseness of the dispersed oil. Consequently, the oil is promoted to float up by increasing the diameter of the particle, so that the oil can be readily recovered.

In this way, only the liquid after the separation of the impurities by the filtration of the membrane of the filter and the separation of the impurities having the higher specific gravity and the component having the lower specific gravity by the specific gravity difference separation is allowed to flow out of the outlet 41a.

As described above, in the filter device 1 in the present embodiment, the particles having a greater diameter, which markedly affects the reduction of a effective filtration area, out of the impurities separated by the membrane of the filter are recovered in the deposit recovery tank R1. As a consequence, the particles cannot stay at the surface of the membrane of the filter, thereby suppressing the reduction of the effective filtration area. Thus, it is possible to enhance the stability of the filtration performance and prolong the lifetime of the filter.

Additionally, in the filter device 1 according to the present embodiment, the separation of the impurities by the filtration of the filter and the separation of the component having the lower specific gravity by the specific gravity difference separation can be performed by the single device. Consequently, it is unnecessary to independently provide a coalescer or the like.

Moreover, in the embodiment, because the above-described sealing mechanism is employed, a sealing with a complicated structure such as an end face seal is unnecessary. Therefore, the configuration can be simplified and assembly can be facilitated, thereby reducing the cost.

Furthermore, in the embodiment, the tip end portion 32 of the cylindrical portion of the bag filter bucket 3 abuts on the position restricting portion 51 as described above. Therefore, even if the filter bag 2 and the bag filter bucket 3 expand due to the inside fluid pressure and the like, pressure between the tip end portion 32 and the position restricting portion 51 can be dispersed.

As a result, problems of pressure concentration in the vicinity of the position restricting portion 51 and deformation due to the pressure concentration do not occur as described above.

In the above description, the configuration of the filter device having both the functions of recovering the deposit and recovering the floating material is shown. However, if the floating material is not contained in the liquid to be filtered, the configuration may have only the function of recovering the deposit.

### SECOND EMBODIMENT

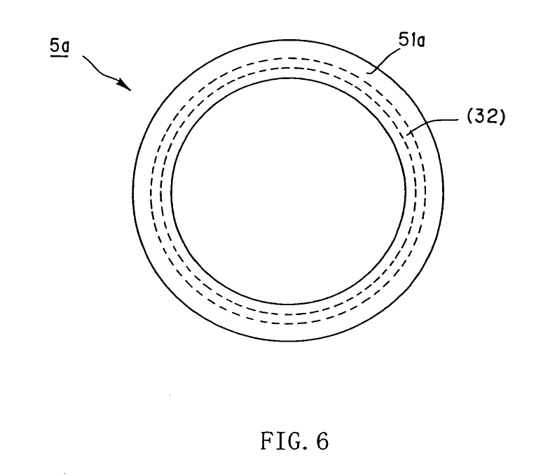

FIG. 6 shows the second embodiment of the invention of the present application. The present embodiment is different from the configuration in the above first embodiment only in a configuration of a housing cover.

Because other structures and operations are similar to those of the first embodiment, descriptions of the similar components will be omitted and only different configurations will be described.

FIG. 6 is a bottom view of the housing cover in a filter device according to the second embodiment of the invention of the present application.

At a lower end of a side wall face of the substantially conical shape of the housing cover 5a in the embodiment, a ring-shaped position restricting portion 51a is provided along a circumference.

In FIG. 6, a position corresponding to the tip end portion 32 of the cylindrical portion of the bag filter bucket 3 is shown in a dotted line. As can be seen from this figure, the whole circular tip end portion 32 abuts on the ring-shaped position restricting portion 51a provided to the housing cover 5a.

Therefore, as compared with the case in which the portion 32 abuts on the portion 51a at four positions as in the above first embodiment, the pressure can be dispersed further effectively. Consequently, it is possible to further effectively solve the problems of pressure concentration in the vicinity of the position restricting portion 51a and the deformation due to the pressure concentration.

### THIRD EMBODIMENT

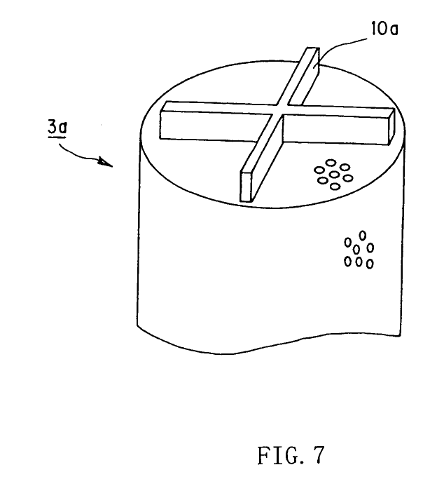

FIG. 7 shows a third embodiment of the invention of the present application. The embodiment is different from the configuration in the above first embodiment only in a configuration of a handle provided to a protecting member (bag filter bucket).

Because other structures and operations are similar to those of the first embodiment, descriptions of the similar components will be omitted and only different configurations will be described.

FIG. 7 is a part of a perspective view of the protecting member (bag filter bucket) in a filter device according to the third embodiment of the invention of the present application.

On an outside face of a bottom of the bag filter bucket 3a in the embodiment, the handle 10a is provided. The handle 10a is formed of a cross-shaped member having longwise and crosswise lengths each substantially equal to a diameter of the cylindrical portion of the bag filter bucket 3a.

By providing such a handle 10a, rigidity of a vicinity of the bottom face portion of the bag filter bucket 3a is increased. Therefore, deformation when pressure is received can be effectively suppressed. It is also possible to disperse the pressure.

For example, if the housing cover has the configuration shown in FIG. 5, the handle 10a may be abutted on the position restricting portion 51 so as to be aligned with the cross-shaped position restricting portion 51. In this manner, the whole surface of the handle 10a on the position restricting portion 51 side abuts on the position restricting portion 51. Consequently, the pressure can sufficiently be dispersed.

If the housing cover has the configuration shown in FIG. 6, the cross-shaped handle 10a abuts on the position restricting portion 51a at four evenly-spaced positions. Therefore, the pressure can be dispersed.

As described above, due to a combination of the effect of increasing the rigidity and the effect of dispersing the pressure, the deformation when the pressure is received can be suppressed further effectively.

### INDUSTRIAL APPLICABILITY

As described above, according to the invention of the present application, both of removal of the impurities by the filtration and removal of the impurities by the specific gravity difference separation are possible and the configuration can be simplified.

1. A filter device comprising:
a bag-like filter for separating particles of impurities contained in a liquid to be filtered;
a protecting member made of a rigid body for protecting the filter and in a shape of a cylinder having a bottom;
a housing for accommodating the filter and the protecting member so that opening portions of the filter and the protecting member are oriented downward, the housing including a housing main body having a cylindrical portion and a housing cover mounted to an end portion of the cylindrical portion of the housing main body, wherein the cylindrical portion having an inlet disposed below the opening portions for leading the liquid to be filtered inside and an outlet disposed above the opening portions for allowing the liquid filtered by the filter to flow outside;
a deposit recovery tank for recovering particles below an opening end of the filter, the particles having higher specific gravity than the liquid to be filtered out of the particles of the impurities separated by the filter; and
a seal for sealing an annular gap between an outer peripheral face of the protecting member and an inner peripheral face of the housing in the vicinity of the opening end of the filter,
wherein a support member is mounted in the housing main body, a position restricting portion is provided to the housing cover, and vertical positioning of the filter and the protecting member is carried out by using the support member and the position restricting portion, and
a tip end portion of a cylindrical portion of the protecting member is brought into contact with the position restricting portion.

2. A filter device comprising:
a bag-like filter for separating particles of impurities contained in a liquid to be filtered;
a protecting member made of a rigid body for protecting the filter;
a housing for accommodating the filter and the protecting member so that an opening portion of the filter is oriented downward, the housing having an inlet disposed below the opening portion for leading the liquid to be filtered inside and an outlet disposed above the opening portion for allowing the liquid filtered by the filter to flow outside;
a deposit recovery tank for recovering particles below an opening end of the filter, the particles having higher specific gravity than the liquid to be filtered out of the particles of the impurities separated by the filter; and
a seal for sealing an annular gap between an outer peripheral face of the protecting member and an inner peripheral face of the housing in the vicinity of the opening end of the filter.

3. The filter device according to claim 1 and further comprising a sleeve fitted with an inner periphery of the housing, wherein the seal forms seal faces respectively on the outer peripheral face of the protecting member and an inner peripheral face of the sleeve.

4. The filter device according to claim 3, wherein a taper for leading the protecting member to a predetermined mounting position in mounting the protecting member in the housing is provided to an end portion of the sleeve.

5. The filter device according to claim 1, further comprising a seal portion for sealing a path of the liquid to be filtered entering a gap between an inner peripheral face of the protecting member and an outer peripheral face of the filter.

6. A filter device comprising:
a bag-like filter for separating particles of impurities contained in a liquid to be filtered;
a protecting member made of a rigid body for protecting the filter and in a shape of a cylinder having a bottom;
a housing for accommodating the filter and the protecting member so that opening portions of the filter and the protecting member are oriented downward, the housing including a housing main body having a cylindrical portion and a housing cover mounted to an end portion of the cylindrical portion of the housing main body, wherein the cylindrical portion having an inlet disposed below the opening portions for leading the liquid to be filtered inside and an outlet disposed above the opening portions for allowing the liquid filtered by the filter to flow outside; and
a deposit recovery tank for recovering particles below an opening end of the filter, the particles having higher specific gravity than the liquid to be filtered out of the particles of the impurities separated by the filter;
wherein a support member is mounted in the housing main body, a position restricting portion is provided to the housing cover, and vertical positioning of the filter and the protecting member is carried out by using the support member and the position restricting portion, and
a tip end portion of a cylindrical portion of the protecting member is brought into contact with the position restricting portion.

7. The filter device according to claim 6, wherein the position restricting portion has an area with which the whole tip end portion of the cylindrical portion of the protecting member is bought into contact.

8. A filter device comprising:
a bag-like filter for separating particles of impurities contained in a liquid to be filtered;
a protecting member made of a rigid body for protecting the filter and in a shape of a cylinder having a bottom;
a housing for accommodating the filter and the protecting member so that opening portions of the filter and the protecting member are oriented downward, the housing including a housing main body having a cylindrical portion and a housing cover mounted to an end portion of the cylindrical portion of the housing main body, wherein the cylindrical portion having an inlet disposed below the opening portions for leading the liquid to be filtered inside and an outlet disposed above the opening portions for allowing the liquid filtered by the filter to flow outside; and
a deposit recovery tank for recovering particles below an opening end of the filter, the particles having higher specific gravity than the liquid to be filtered out of the particles of the impurities separated by the filter,
wherein a support member is mounted in the housing main body, a position restricting portion is provided to the housing cover, and vertical positioning of the filter and the protecting member is carried out by using the support member and the position restricting portion,
a cross-shaped handle having longwise and cross wise lengths each substantially equal to a diameter of the protecting member is provided to an outside face of a bottom of the protecting member, and the handle is brought into contact with the position restricting portion.

9. The filter device according to claim 8, wherein the position restricting portion has an area with which the whole surface of the handle on the position restricting portion side is bought into contact.

10. The filter device according to claim 1, further comprising a floating material recovery tank for recovering components having lower specific gravity out of the liquid filtered by the filter.
